(19) United States
(12) Patent Application Publication
(10) Pub. No.: US 2008/0282811 A1
(43) Pub. Date: Nov. 20, 2008

(54) Monitoring Device for Sensing the Rotation Speed and the Torque in a Shaft

(75) Inventor: Adrian William Hill, Jersey (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MELEXIS NV, Ieper (BE)

(21) Appl. No.: 11/663,791

(22) PCT Filed: Sep. 27, 2005
(86) PCT No.: PCT/IB05/02841

§ 371 Date: Mar. 3, 2008

(30) Foreign Application Priority Data
Sep. 27, 2004 (GB) 0421383.1

(51) Int. Cl. G01L 3/10

(52) U.S. Cl. 73/862.333

(57) ABSTRACT

To monitor the rotation speed and torque transmitted by a shaft (120) in order to determine the power transmitted by the shaft (120). To achieve this torque sensing means 124 and rotation speed sensing means (103) are provided, each connected to an interface means (104). Signals are transmitted between said torque sensing means (124) and said interface means (104) by way of a coupling arrangement comprising a first coupling element (121) is fixed to and co-rotates with shaft (120) and a second coupling element (102) is fixed to a stator (101) surrounding said shaft (120) and thus remains stationary whilst shaft (120) rotates. The first coupling element (121) is in the form of a split ring having a ring gap (127) and is electrically connected to the torque sensing means (124). The first coupling element (121) has a comb-like form wherein the ring provides a spine upon which are formed a plurality of teeth (122), which project from said spine. The second coupling element (102) is in the form of a split ring having a ring gap. The interface means (104) is electrically connected (108, 109) to each side of the ring gap. The rotation speed sensing means (103) comprises a pair of Hall elements (103), mounted on or adjacent to the stator (101). The Hall elements (103) are operable to detect the local magnetic field, and output a signal indicative thereof to the interface means (104). As the shaft (120) rotates, the alternating teeth (122) and gaps of the first coupling element (121) (which being fixed to the shaft (120) co-rotates with the shaft (120)) cause fluctuations in the local magnetic field detectable by the Hall elements (103).

The present invention relates to a monitoring device for a shaft and in particular to a monitoring device for a shaft operable to determine the torque transmitted by the shaft as it rotates and the rotation speed of the shaft and more particularly to such a monitoring device which is additionally operable to determine the power transmitted by the shaft.

In order to manage the operation of an internal combustion engine in an effective and environmentally efficient manner, the engine management unit requires accurate information from sensors mounted throughout the engine. Of particular importance are sensors mounted on the drive shaft providing information relating to torque transmitted by the drive shaft and the rotation speed of the drive shaft hence allowing the calculation of the power transmitted by the drive shaft.

A common type of sensor for detecting the rotation speed of a shaft comprises a Hall effect sensing element (Hall element). Hall elements are operable to detect local magnetic fields and output a corresponding electrical signal. In this context, one or more Hall elements are provided adjacent to the shaft, the Hall elements being operable to detect fluctuations in the local magnetic field as the shaft rotates. The field fluctuations are caused by variations in the magnetic properties of the shaft around its circumference. These may be due to projections/cavities in the shaft surface, if the shaft material exhibits magnetic properties or magnetic material attached to the shaft. As the shaft rotates, these fluctuations can be detected and the rotation speed of the shaft calculated.

Conventional torque sensors for rotating shafts monitor the strain on the surface of the shaft to determine the transmitted torque. Known means for monitoring of this form include electronic strain gauges; optical torque transducers; or surface acoustic wave (SAW) resonators as disclosed in U.S. Pat. No. 5,585,571.

As it is necessary to determine both the rotation speed and the transmitted torque, in order to calculate the power transmitted by the drive shaft, if it is desired to monitor the power transmitted by the drive shaft, sensing means for both rotation speed and transmitted torque must be provided. The necessity to provide two sensors rather than a single sensor means that a relatively large space will be taken up by the monitoring device, the cost of manufacturing and fitting the device will be relatively large and the probability of a failure will also be relatively large.

It is therefore an object of the present invention to provide a new device for monitoring transmitted torque and rotation speed of a shaft.

According to a first aspect of the present invention there is provided a monitoring device suitable for sensing the rotation speed and the torque transmitted by a rotating shaft comprising:

torque sensing means mounted on said shaft, said torque sensing means being operable to monitor the shaft and thereby output a signal indicative of the torque transmitted by the shaft;

rotation sensing means mounted adjacent to said shaft, said rotation sensing means comprising a hall element operable to detect fluctuations in local magnetic flux as the shaft rotates and thereby output a signal indicative of the shaft rotation; and

interface means mounted adjacent to said shaft and operable to receive said signals output by said torque sensing means and said rotation sensing means, wherein the output of said torque sensing means is output to said interface means via a coupling arrangement comprising:

a first coupling element electrically connected to said torque sensor and mounted on said shaft so as to co-rotate with said shaft; and

a second coupling element electrically connected to said interface means and mounted on a stator positioned around said shaft so as to remain stationary relative to the rotation of the shaft, signals being transmitted between said coupling elements by non-contact coupling,

wherein said first coupling element comprises a spine and a plurality of teeth, said teeth causing fluctuations in the local magnetic field adjacent to the shaft, as the shaft rotates.

This thus provides a combined rotation speed and transmitted torque sensing arrangement. By combining the two functions in a single arrangement, manufacturing and fitting costs can be reduced, reliability can be increased and the overall space occupied by the arrangement can be reduced.

Preferably the spine of the first element in said coupling arrangement comprises a split ring mounted on or around the circumference of the shaft and acting as an antenna or single turn coil. The teeth provided on said spine may project from the spine parallel to the axis of the shaft or perpendicularly to the axis of the shaft as desired or appropriate. The teeth are preferably regularly sized and spaced along the spine and most preferably have a generally rectangular profile.

The torque sensing means may be electrically connected between the ends of said split ring comprising said first coupling element. The first coupling element may be formed of a material that exhibits permanent magnetic properties in addition to being electrically conductive.

The rotation sensing means may comprise one or more Hall elements mounted adjacent to the portion of shaft carrying the first coupling element. In this manner the Hall element or elements are conveniently located such that they can detect fluctuations in the local magnetic field as the shaft (and hence the first coupling element) rotates.

The Hall element or elements are provided on a suitable substrate or on one or more suitable substrates. The substrate or substrates may be conveniently mounted on the stator. The interface means may be provided upon the same substrate as one or more of the Hall elements.

Preferably, the second element of the coupling arrangement is a split ring, the split ring being positioned around the portion of the shaft carrying the first coupling element. In this manner the second element is conveniently located adjacent to the first element allowing signals to be transmitted between the two coupling elements by non-contact coupling. The coupling arrangement is preferably adapted to transmit signals between the first and second coupling elements by RF coupling between the first and second coupling elements. It is of course possible that the coupling between the first and second coupling elements may alternatively be achieved by inductive or capacitive coupling.

The interface means is preferably electrically connected between the two ends of the split ring comprising the second coupling element. The interface means is operable to receive signals from said torque sensing means and said rotation speed sensing means. The interface means preferably also comprises means for outputting a signal or signals to external circuitry. The output signals may be the signals received from the torque sensing means and the rotation speed sensing means.

The interface means may additionally comprise a processing unit for processing signals received from said torque sensing means and said Hall rotation speed sensing means. The processing unit is preferably operable to generate analogue and/or digital output signals indicative of the rotation speed, transmitted torque and transmitted power of the shaft.

Whilst the invention may be implemented with torque sensing means comprising one or more strain gauges or optical transducers, preferably the torque sensor means comprises a pair of Surface Acoustic Wave (SAW) resonators mounted on the surface of said shaft. Preferably, the SAW resonators are mounted on the shaft in an arrangement wherein when the shaft is rotated and transmitting torque one of the said SAW resonators is under tensile strain and the other SAW resonator is under compressive strain. Most preferably, the SAW resonators are arranged on the shaft such that they lie perpendicular to each other and each at 45° to the shaft rotation axis.

In embodiments wherein the torque sensing means are SAW resonators, preferably an RF driving signal is input to the SAW resonators via the coupling arrangement. Most preferably, the RF driving signal is generated by an RF signal generator incorporated into the interface means.

Preferably, the monitoring device is adapted to be fitted to a shaft of an engine or a shaft driven by an engine. In particular, the shaft may be the drive shaft of said engine. In such embodiments, the interface means may output signals to an engine control unit.

The device may be fitted to any suitable shaft in any suitable type of engine, including but not limited to internal combustion engines, electric motors, gas turbines or similar. In such embodiments, the external control unit is preferably an engine management unit.

In order that the invention is more clearly understood, it will now be described further herein with reference to the accompanying drawings, in which:

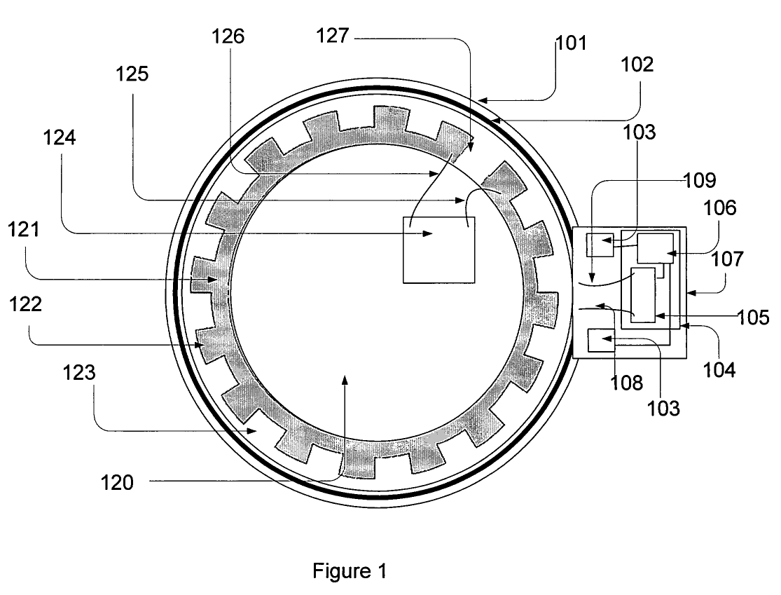

FIG. 1 shows a sectional view of a first embodiment of a combined rotation speed and transmitted torque sensor according to the present invention; and

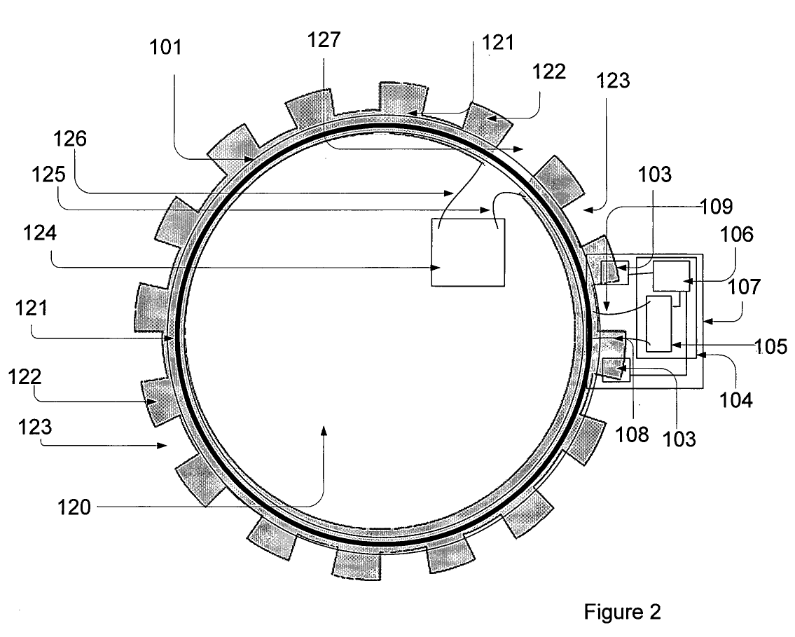

FIG. 2 shows a sectional view through an alternative embodiment of a combined rotation speed and transmitted torque sensor according to the present invention.

Referring now to FIG. 1, it is desired to monitor the rotation speed and torque transmitted by a shaft 120 in order to determine the power transmitted by the shaft 120. To achieve this torque sensing means 124 and rotation speed sensing means 103 are provided, each connected to an interface means 104.

The torque sensing means 124 comprise a pair of Surface Acoustic Wave (SAW) resonators (not shown) mounted on the surface of the shaft 120. The SAW resonators are mounted on the surface of the shaft 120 in such a manner that they experience the tensile or compressive strain as the local shaft surface. The SAW resonators are mounted perpendicular to one another and each at 45° to the rotation axis of the shaft. In this way, when the shaft 120 turns, one of the SAW resonators experiences tensile strain whilst the other experiences compressive strain.

An RF driving signal is input to the SAW resonators and as a result the resonators output a corresponding RF signal at their resonant frequency. As a result of the strain on the SAW resonators, the resonators are deformed and their resonant frequency varies. The amount of variation is related to the amount of strain the SAW resonator is exposed to and hence by analysing the output signals from both SAW resonators, the torque transmitted by the shaft can be determined. This technique is discussed further in U.S. Pat. No. 5,585,571.

The RF signals for input to the SAW resonators are generated by an RF signal generator 105 incorporated into the interface means 104. The RF signal generator 105 may additionally be operable to receive RF signals output by the SAW resonators. Signals are transmitted between said resonators and said interface means 104 by way of a coupling arrangement.

The coupling arrangement comprises a pair of coupling elements, a first coupling element 121 is fixed to and co-rotates with shaft 120 and a second coupling element 102 is fixed to a stator 101 surrounding said shaft 120 and thus remains stationary whilst shaft 120 rotates. The elements are arranged such that RF signals input to one element induce corresponding RF signals in the other element due to RF coupling between the elements.

The first coupling element 121 is in the form of a split ring having a ring gap 127. Electrical connections 125 and 126 are made between the torque sensing means 124 and the first coupling element 121, a separate connection being made to each side of the ring gap 127.

The coupling element 121 has a comb-like form wherein the ring provides a spine upon which are formed a plurality of teeth 122, which project from said spine. Gaps 123 are provided between the teeth 122. In FIGS. 1 and 2, the teeth 122 project from the spine in directions perpendicular to the axis of the shaft 120. It is of course possible that in alternative embodiments, the teeth 122 may be arranged to project in directions parallel to the axis of the shaft 120. The teeth 122 are typically equally spaced around the split ring forming the first coupling element 121. In a particularly preferred arrangement, shown in FIGS. 1 and 2, teeth 122 are provided on each side of the ring gap 127. Ring gap 127 typically has the same width as gaps 123 between the teeth 122.

The second coupling element 102 is in the form of a split ring having a ring gap. The interface means 104 is connected via electrical connections 108, 109 to each side of the ring gap. In the arrangement of FIG. 1, the second coupling element 102 is located radially outside the first coupling element 121. This allows RF signals to be passed between the interface means 104 and the torque sensing means 124 via the coupling arrangement.

The rotation speed sensing means 103 comprises a pair of Hall elements 103, provided on a substrate 107 mounted on or adjacent to the stator 101. The interface means is additionally provided on the same substrate 107.

In alternative embodiments, more or fewer Hall elements 103 may be provided as desired or appropriate. If a plurality of Hall elements 103 are provided, the Hall elements 103 may be mounted adjacent to one another or spaced apart from one another as desired or as appropriate.

The Hall elements 103 are operable to detect the local magnetic field, and output a signal indicative thereof to the interface means 104. As the shaft 120 rotates, the alternating teeth 122 and gaps of the first coupling element 121 (which being fixed to the shaft 120 co-rotates with the shaft 120) cause fluctuations in the local magnetic field detectable by the Hall elements 103. In order that these fluctuations are more readily detectable, the first coupling element 121 is formed from a material that conducts electricity and exhibits magnetic properties.

A biasing magnetic field may additionally be provided to increase the detectability of these fluctuations. Such a biasing field may be provided by biasing magnets located adjacent to each Hall element.

Referring now to FIG. 2, an alternative embodiment of the invention is shown wherein the stator 101 and hence the second coupling element 102 are located radially alongside rather than outside the first coupling element 121. This arrangement reduces the overall diameter of the complete assembly when compared with the embodiment of FIG. 1.

A further reduction in the overall diameter can be achieved by using a first coupling means 121 having teeth which project parallel to rather than perpendicular to the axis of the shaft 120. Such a coupling means could of course be used with the radially outside location of the second coupling means 102 shown in FIG. 1 also.

The interface means is provided with processing means 106 operable to receive signals from the Hall elements 103 and process said signals to determine the rate of rotation of the shaft 120. This is typically achieved by counting fluctuations in the local magnetic field associated with the teeth 122 on the first coupling element 121 to determine the number of revolutions that the shaft 120 has made in a predetermined time period. A number of methods of processing the output of a Hall element to determine revolution rate are well known in the art. The processing means 106 is further operable to output signals indicative to the rotation speed of the shaft 120 to external circuitry.

The processing means 106 may additionally be operable to receive RF signals from said torque sensing means 124 and to process said signals to determine the torque transmitted by the shaft 120 and to output signals indicative thereof to external circuitry. The processing means 106 may also be operable to calculate the power transmitted by the shaft 120 from the determined values of the rotation speed and the transmitted torque.

Typically, the monitoring device would be provided on a shaft in an engine or on a shaft driven by an engine. In particular, it is envisaged that the device may be provided on the drive shaft of the engine of a motor vehicle e.g. a car, van, truck, lorry, motorcycle etc. In such circumstances the processing means would be operable to output signals indicative of any or all of the shaft rotation rate, transmitted torque and transmitted power to an engine control unit. This information allows the engine control unit to monitor and optimise engine performance.

In alternative embodiments, the interface means 104 may omit the processing means 106 and be operative merely to receive signals output by the Hall elements 103 and the torque sensing means 124 and output said signals to external circuitry for processing and/or analysis.

It is of course to be understood that the invention is not to be limited to the details of the above embodiments which are described by way of example only.

1. A monitoring device suitable for sensing the rotation speed and the torque transmitted by a rotating shaft comprising: torque sensing means mounted on said shaft, said torque sensing means being operable to monitor the shaft and thereby output a signal indicative of the torque transmitted by the shaft; rotation sensing means mounted adjacent to said shaft, said rotation sensing means comprising a hall element operable to detect fluctuations in local magnetic flux as the shaft rotates and thereby output a signal indicative of the shaft rotation; and interface means mounted adjacent to said shaft and operable to receive said signals output by said torque sensing means and said rotation sensing means, wherein the output of said torque sensing means is output to said interface means via a coupling arrangement comprising: a first coupling element electrically connected to said torque sensor and mounted on said shaft so as to co-rotate with said shaft; and a second coupling element comprising a split ring electrically connected to said interface means and mounted on a stator positioned around said shaft so as to remain stationary relative to the rotation of the shaft, signals being transmitted between said coupling elements by non-contact coupling, wherein said first coupling element comprises a split ring mounted on or around the circumference of the shaft a spine and a plurality of teeth, said teeth causing fluctuations in the local magnetic field adjacent to the shaft, as the shaft rotates.

2. A monitoring device as claimed in claim 1 wherein the spine of the first element in said coupling arrangement acts as an antenna or single turn coil.

3. A monitoring device as claimed in claim 1 wherein the teeth provided on said spine project from the spine parallel to the axis of the shaft.

4. A monitoring device as claimed in claim 1 wherein the teeth provided on said spine project from the spine perpendicularly to the axis of the shaft.

5. A monitoring device as claimed in claim 1 wherein the teeth are regularly sized and spaced along the spine.

6. A monitoring device as claimed in claim 1 wherein the teeth have a generally rectangular profile.

7. A monitoring device as claimed in claim 1 wherein the torque sensing means is electrically connected between the ends of said split ring comprising said first coupling element.

8. A monitoring device as claimed in claim 1 wherein the first coupling element is formed of a material that exhibits permanent magnetic properties in addition to being electrically conductive.

9. A monitoring device as claimed in claim 1 wherein the rotation sensing means comprises one or more Hall elements mounted adjacent to the portion of shaft carrying the first coupling element.

10. A monitoring device as claimed in claim 9 wherein the Hall element or elements are provided on a suitable substrate.

11. A monitoring device as claimed in claim 9 wherein the Hall elements are provided on one or more suitable substrates.

12. A monitoring device as claimed in claim 10 or claim 11 wherein the substrate or substrates are mounted on the stator.

13. A monitoring device as claimed in claim 10 or claim 11 wherein the interface means is provided upon the same substrate as one or more of the Hall elements.

14. A monitoring device as claimed in claim 1 wherein the second element of the coupling arrangement is positioned around the portion of the shaft carrying the first coupling element.

15. A monitoring device as claimed in claim 1 wherein signals are transmitted by RF coupling.

16. A monitoring device as claimed in claim 1 wherein signals are transmitted by inductive or capacitive coupling.

17. A monitoring device as claimed in claim 1 wherein the interface means is electrically connected between the two ends of the split ring comprising the second coupling element.

18. A monitoring device as claimed in claim 1 wherein the interface means is operable to receive signals from said torque sensing means and said rotation speed sensing means.

19. A monitoring device as claimed in claim 1 wherein the interface means comprises means for outputting a signal or signals to external circuitry.

20. A monitoring device as claimed in claim 19 wherein the output signals are the signals received from the torque sensing means and the rotation speed sensing means.

21. A monitoring device as claimed in claim 1 wherein the interface means comprises a processing unit for processing signals received from said torque sensing means and said Hall rotation speed sensing means.

22. A monitoring device as claimed in claim 21 wherein the processing unit is operable to generate analogue and/or digital output signals indicative of the rotation speed, transmitted torque and transmitted power of the shaft.

23. A monitoring device as claimed in claim 1 wherein the torque sensor means comprises a pair of Surface Acoustic Wave (SAW) resonators mounted on the surface of said shaft.

24. A monitoring device as claimed in claim 23 wherein the SAW resonators are mounted on the shaft in an arrangement wherein when the shaft is rotated and transmitting torque one of the said SAW resonators is under tensile strain and the other SAW resonator is under compressive strain.

25. A monitoring device as claimed in claim 23 wherein the SAW resonators are arranged on the shaft such that they lie perpendicular to each other and each at 45° to the shaft rotation axis.

26. A monitoring device as claimed in claim 23 wherein an RF driving signal is input to the SAW resonators via the coupling arrangement.

27. A monitoring device as claimed in claim 26 wherein the RF driving signal is generated by an RF signal generator incorporated into the interface means.

28. A monitoring device as claimed in claim 1 wherein the monitoring device is adapted to be fitted to a shaft of an engine or a shaft driven by an engine.

29. A monitoring device as claimed in claim 28 wherein the interface means outputs signals to an engine control unit.

30. A monitoring device as claimed in claim 28 wherein the engine is any one of an internal combustion engine, an electric motor or a gas turbine.
